(19) United States
(12) Patent Application Publication
(10) Pub. No.: US 2008/0319766 A1
(43) Pub. Date: Dec. 25, 2008

(54) Subscription-based catastrophe-triggered transport services facilitation method and apparatus

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/381,257

(22) Filed: May 2, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.

(51) Int. Cl. G06Q 99/00; G01C 21/20; G05D 1/02

(52) U.S. Cl. 705/1; 701/23

(57) ABSTRACT

One or more non-human-powered vehicles (203, 204) are pre-positioned and maintained at a predetermined location (202). Consideration-based private civil security subscriptions (201) are then accepted from subscribers with respect to providing civilly-catastrophic event-based transport on the non-human-powered vehicle away from a location of substantially sudden civil upheaval. By one approach this non-human-powered vehicle is reserved, maintained, and used substantially solely as a transport response to a civilly-catastrophic event.

### RELATED APPLICATIONS

This comprises a continuation-in-part of three earlier filed patent applications entitled:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350; and

PERSONAL PROFILE-BASED PRIVATE CIVIL SECURITY SUBSCRIPTION METHOD as filed on Apr. 11, 2006 and having application Ser. No. 11/279,333; the contents of which are fully incorporated herein by this reference.

This application relates to the following patent applications as were filed on even date herewith (wherein the contents of such patent applications are incorporated herein by this reference):

FRACTIONALLY-POSSESSED UNDERGROUND SHELTER METHOD AND APPARATUS (attorney's docket number 8379/87822);

SUBSCRIPTION-BASED MULTI-PERSON EMERGENCY SHELTER METHOD (attorney's docket number 8379/87823); and

SUBSCRIPTION-BASED CATASTROPHE-TRIGGERED RESCUE SERVICES FACILITATION METHOD AND APPARATUS (attorney's docket number 8379/87824).

### TECHNICAL FIELD

This invention relates generally to providing transport services.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related interactions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swatch of a given civil community. Any number of natural and/or human-caused events can sufficiently disrupt society's infrastructure and ability to provide one or more life-sustaining resources such as water, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs.

When a civilly-catastrophic event occurs, substantially sudden civil upheaval will often follow. Such upheaval, which can occur even without the advent of an uncooperative and/or panicked populace, can in turn lead to considerable survival-related problems for persons within the affected location. In many cases it may be useful or even critical to at least temporarily evacuate the troubled location. Therein, however, lies something of a conundrum. On the one hand, modern governments typically do little to proactively ensure the ability to quickly and safely effect mass transport of their citizens in the face of most civilly-catastrophic events. On the other hand, attempting to take responsible actions to reasonably ensure one's own abilities in this regard can become, in and of itself, a seemingly insurmountable challenge.

### BRIEF DESCRIPTION OF THE DRAWINGS

The above needs are at least partially met through provision of the subscription-based catastrophe-triggered transport services facilitation method and apparatus described in the following detailed description, particularly when studied in conjunction with the drawings, wherein:

FIG. 1 comprises a flow diagram as configured in accordance with various embodiments of the invention; and

FIG. 2 comprises a block diagram view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one or more non-human-powered vehicles are pre-positioned and maintained at a predetermined location. Consideration-based private civil security subscriptions are then accepted from subscribers with respect to providing civilly-catastrophic event-based transport on the non-human-powered vehicle away from a location of substantially sudden civil upheaval. By one approach this non-human-powered vehicle is reserved, maintained, and used substantially solely as a transport response to a civilly-catastrophic event.

The nature of the non-human-powered vehicle can vary with the needs and/or opportunities as characterize a given application setting. Various kinds of transport modality, for example, can be accommodated in this manner. This can include air-borne vehicles, terrestrial vehicles, water-borne vehicles, and so forth. The number of non-human-powered vehicles provided at the predetermined location can vary as well. For example, by one approach, a sufficient number of vehicles can be provided to ensure a fully redundant back-up capability to transport the full number of authorized beneficiaries as correspond to the transport subscriptions.

By one approach this non-human-powered vehicle is maintained as described sans full-time human oversight. By another approach, however, one or more full-time crew members are maintained at the predetermined location to provide a constantly-available transport asset.

These steps are facilitated without dependency upon governmental oversight, participation, or control. The particular transport services provided can vary with the needs and requirements of the authorized beneficiaries. Importantly, via these teachings an individual can take important steps to bring a considerably improved measure of security into their lives, knowing that, should a civilly-catastrophic event indeed be visited upon them, they will have extraordinary access to transport that is capable of safely and effectively moving them from a location of substantially sudden civil upheaval.

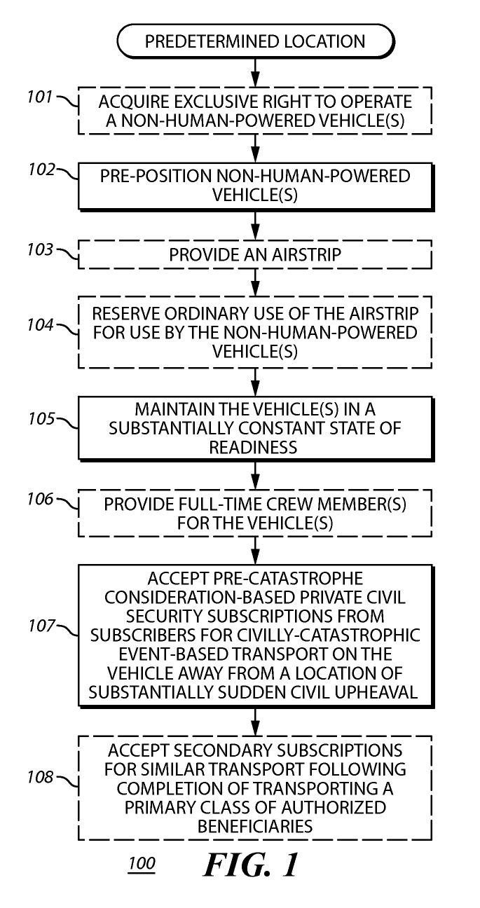

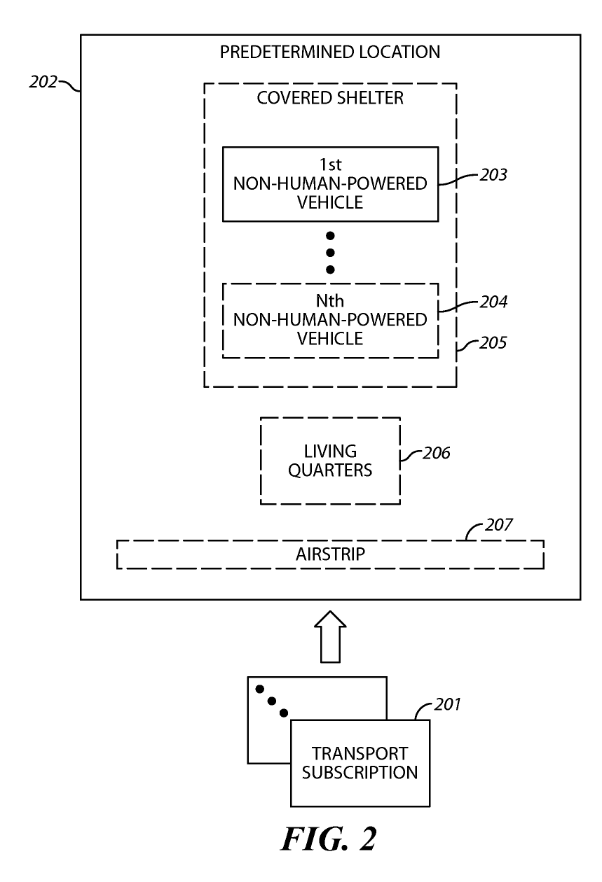

These and other benefits may become clearer upon making a thorough review and study of the following detailed description. Referring now to both FIG. 1 and FIG. 2, an illustrative process 100 provides for pre-positioning 102 at least one non-human powered vehicle 203 at a predetermined location 202. By one approach this may comprise, or be preceded by, optionally acquiring 101 an exclusive right to operate the non-human powered vehicle 203. There are many ways by which such an exclusive right can be so acquired. A non-exhaustive listing might include, but is not limited to, acquiring the exclusive right via ownership, leasing, rental, or even a barter arrangement.

The non-human powered vehicle 203 itself can vary greatly with respect to the actual and/or anticipated circumstances as may concern its eventual use as a means of transporting others away from a location of substantially sudden civil upheaval as has been occasioned by a civilly-catastrophic event. This can include differences with respect to the transport modality (or modalities) that characterizes the non-human powered vehicle 203. Examples include, but are not limited to, air-borne vehicles (including fixed wing aircraft, helicopters, and hovercraft, to note but a few), terrestrial vehicles (including cars, buses, trucks, and trains, to note but a few), and water-borne vehicles (including boats and ships, submarines, and amphibious craft, again to note but a few relevant examples). In many cases the non-human powered vehicle 203 will comprise a piloted vehicle that requires an in-vehicle pilot. If desired, however, the non-human powered vehicle 203 may also comprise a pilotless vehicle or a remotely piloted vehicle (where the vehicle operates under the control of an automated control system, a remotely-located pilot, or some combination thereof).

In many cases the non-human powered vehicle 203 will comprise a terrestrial vehicle. In such a case it may be useful to configure and arrange the non-human powered vehicle 203 to be able to traverse off-road conditions. Such a capability may be useful, for example, to successfully move past debris, stalled, blocked, or abandoned vehicles, impassable roadways, and so forth. This can comprise configuring the vehicle with a higher-than-normal suspension, a heavy-duty suspension, all-wheel drive, and so forth. This may also comprise configuring the vehicle's engine to operate even when partially or fully submerged (as may occur when fording a flooded area). Such accoutrements are known in the art and require no further elaboration here.

In many cases the non-human powered vehicle 203 will comprise a terrestrial vehicle that has a free-ranging capability to thereby freely navigate paved and unpaved surfaces of various kinds. In some cases, however, it may be useful to further configure and arrange the vehicle to also selectively travel compatibly on railroad tracks. This may comprise, for example, outfitting the vehicle with retractable flanged wheels that can be selectively lowered to interact compatibly with a set of railroad tracks. Such apparatus is known in the art. So configured, the non-human powered vehicle 203 can selectively readily travel on railroad tracks which may, in a given time of need, comprise a relatively unblocked means of departing from a location of civil upheaval.

In many cases the non-human powered vehicle 203 will be configured and arranged to transport human passengers. As will be shown below in more detail, these human passengers may comprise, for example, the authorized beneficiaries of certain subscriptions 201 as pertain to accessing and using the non-human powered vehicle. If desired, however, the non-human powered vehicle 203 may further be configured to additionally transport non-human cargo. This cargo may comprise consumables to support the passengers during the aforementioned transport, personal items that belong to the passengers, and so forth.

In at least some cases it may be anticipated that the civilly-catastrophic event of concern and/or the corresponding civil upheaval may involve, at least in part, unhealthy and/or dangerous ambient airborne contaminants. Examples include, but are not limited to, dangerous biological elements, dangerous chemical elements, dangerous radioactive elements, and so forth. These examples include both man-made and natural contaminants; for example, “chemical elements” can include both a man-made nerve gas and volcanic ash. By one approach, then, the non-human powered vehicle 203 can comprise one or more passenger cabins that are substantially airtight. If desired, this can comprise configuring and arranging the passenger cabin to selectively have positive air pressure when desired to aid in urging external airborne contaminants from entering the passenger cabin. Various ways and means are known in the art by which to provide positive air pressure in a contained space and therefore require no further detailed description here.

At least some civilly-catastrophic events may be accompanied by an electromagnetic pulse. Such a pulse can permanently damage many electrical circuits including, for example, the electronic engine controls for a vehicle. With this in mind, it may be desirable to harden at least the critical vulnerable systems of the non-human powered vehicle 203 to thereby substantially protect those systems against an electromagnetic pulse. Again, various ways and means of achieving such a result are known in the art and may be practiced here as desired.

As already alluded to above, and as will be made more clear below, the purpose of pre-positioning the non-human powered vehicle 203 is to ensure its availability during a time of great need. Unfortunately, such a time will, essentially be definition, be characterized by significant temporary or permanent problems with the infrastructure of modern life. As a result, various significant mission-threatening problems can arise when seeking to use the non-human powered vehicle 203 to transport a group of passengers away from a location of civil upheaval during such a time. As a result, it may be desirable to further outfit the non-human powered vehicle 203 in various other ways to better improve the prospects of the vehicle being able to successfully carry out its transport mission.

This can comprise pre-supplying the non-human powered vehicle 203 with any of a variety of material that is designed to facilitate at least one of improving survivability of the passengers, improving the likelihood that the vehicle can complete its designated travel, and so forth. Examples in this regard include, but are certainly not limited to:
body armor (designed to stop at least low caliber small arms fire and offering higher ballistic protection if desired, including both bulletproof windows, louvered view ports, and armored passenger compartments and/or vehicle compartments);
radiation shielding;
biological/chemical agent protection (including but not limited to the aforementioned positive air pressure capability, decontamination facilities, sealed compartments, and so forth);
medical supplies (including but not limited to first aid supplies as well as first responder emergency medical services supplies such as blood, plasma, automatic external defibrillators, radiation exposure treatments, chemical exposure treatments, antibiotics (including but not limited to medicines such a Tamiflu and the like), and so forth);
spare vehicle parts (including but not limited to mission critical parts relating to the vehicle's drive train, propulsion system, trajectory controls, an electronic control module (ECM), and so forth);
vehicular maintenance tools;
non-lethal weapons and ammunition; and
supplemental vehicular fuel supplies (carried in on-board auxiliary fuel tanks and/or non-integral fuel containers of choice).

Such maintenance can also optionally comprise making adjustments to such supplies to reflect dynamically changing circumstances as occur during the consideration-based private civil security subscription period. As one illustration, a new item may become available that is particularly useful in dealing with or otherwise surmounting some condition that may likely arise upon the occurrence of a particular kind of civilly-catastrophic event. In such a case, maintaining such supplies can readily accommodate updating the acquired and stored items to include a supply of this new item.

Accordingly, such maintenance can readily comprise one or more of removing a particular one of the stored items (as when a better substitute becomes available, when the item itself is shown to be less effective for its intended purpose than was originally thought, and so forth), adding additional ones of a particular item (as when it becomes subsequently understood that more of a particular item is desirable to achieve a particular goal or purpose), adding at least one new stored item that is not already stored (as illustrated in the example provided above), and so forth.

As already noted above, this step can comprise pre-positioning more than one non-human powered vehicle. In many cases it will be desirable to pre-position at least two such vehicles. When providing a plurality of non-human powered vehicles, their transport modalities may be the same or may differ as desired. By one approach this additional vehicle 204 (or vehicles) can serve as redundant capacity and hence as a backup for the first vehicle 203. By this approach, the second vehicle 204 can comprise, for example, passenger transport capacity that at least doubles the overall available transport capacity as is represented by the aforementioned subscriptions. Such redundancy with respect to capacity can aid with assuring, in turn, that transport for the passengers can be effected notwithstanding the difficult circumstances likely to characterize their transit.

By one approach, if desired, a first non-human powered vehicle 203 can comprise a passenger vehicle that is intended to transport a particular group of passengers while a second (and/or more) non-human powered vehicle 204 comprises a security vehicle that is intended to accompany the first non-human powered vehicle 203 when the first non-human powered vehicle 203 makes its assigned transit. So configured, this security vehicle can be intended to perform such tasks as scouting candidate paths ahead of the first non-human powered vehicle 203, following the first non-human powered vehicle 203, or other security/protection related tasks as may be strategically or tactically advisable or useful in a given application setting.

As noted above, if desired the non-human powered vehicle 203 can comprise an airborne vehicle. In some cases such an airborne vehicle will require or benefit from an airstrip. Accordingly, if desired, this process 100 can optionally comprise providing 103 an airstrip 207 at the predetermined location 202. When provided, of course, such an airstrip 207 should be of sufficient length, width, and durability as to accommodate the airborne non-human powered vehicle of choice. This airstrip 207 can further be provided with lighting, markings, electronic navigation aids, and/or control tower facilities as desired. By one approach, this airstrip 207, when provided, is reserved 105 for ordinary use by only the pre-positioned non-human powered vehicle 203 (and/or other vehicles as shall be allied with the subscribed-to purpose). By this approach the airstrip 207 would be closed to other unrelated traffic and purposes.

This process 100 also provides for maintaining 105 the non-human powered vehicle 203 in a substantially constant state of readiness at the predetermined location 202. This can comprise, in part, optionally maintaining and storing the non-human powered vehicle 203 in a covered shelter 205 at the predetermined location 202 for at least a substantial period of time pending a civilly-catastrophic event. This covered shelter 205 can be configured to house a plurality of such vehicles if desired. By one approach the covered shelter 205 may essentially comprise only a roof. By another approach the covered sheltered may also comprise one or more walls as well to further aid in protecting the vehicle(s) from the elements, unauthorized access, prying eyes, and so forth.

Much is known in the art regarding construction and maintenance of covered shelters (including both above ground and below ground facilities). Such a construction will usually at least serve to protect the vehicles and their supplies from environmental stress and extremes. In addition to walls and a roof as previously mentioned such a covered shelter may also optionally comprise internal temperature control, lighting, storage facilities, sleeping facilities, food preparation facilities, personal hygiene facilities, and so forth. For present purposes such a covered shelter may also be equipped to provide for water treatment (such as filtering, bacteria removal, and so forth), waste treatment and/or recycling, electrical power generation, and/or air treatment (including but not limited to conditioning, filtering, and so forth). By one approach such a covered shelter can also be equipped with communication facilities including a variety of wireless broadcast capabilities, long-distance two-way communications capabilities, and so forth.

Such a covered shelter 205 can also comprise appropriate medical services facilities to facilitate the treatment of injured evacuees. These can comprise space, equipment, and other operational needs as may be necessary or useful to preserve and/or facilitate the offering of such medical services. This can include, but is not limited to, diagnostic equipment and supplies, medical procedure facilities (including surgical theaters), recovery facilities, laboratories, pharmaceutical storage facilities, reference materials, and meeting and personal accommodation space and facilities for the medical services personnel themselves.

This step of maintaining 105 the non-human powered vehicle 203 can also comprise one or more maintenance activities. Examples include, but are not limited to:
conducting vehicle maintenance;
providing a supplemental supply of fuel in relatively close proximity to the non-human-powered vehicle, which supplemental supply of fuel is dedicated to use with the non-human powered vehicle(s) at the predetermined location;
providing a store of spare parts for the non-human powered vehicle at the predetermined location;
test-driving the non-human powered vehicle from time to time (for example, on a scheduled basis and/or an un-scheduled basis); and
test-operating the non-human powered vehicle from time to time.

If desired, this process 100 can also optionally comprise providing 106 at least one full-time crew member for the non-human powered vehicle 203. By one approach this can comprise providing living quarters 206 at the predetermined location such that the at least one full-time crew member is available to facilitate substantially immediate operation of the non-human powered vehicle 203 in response to a civilly-catastrophic event. The duties of this crew member can and will vary with the specific kind of vehicle and also with the nature of the particular transport task to be assigned to a particular vehicle. Exemplary duties comprise, but are not limited to, piloting the vehicle, co-piloting the vehicle, navigating the vehicle, conducting two-way wireless communications on behalf of the vehicle during transit, managing, serving, and otherwise attending to the needs of passengers, providing security, and so forth.

Regardless of whether full-time crew members are pre-provisioned as described above, the aforementioned maintenance of the non-human powered vehicle 203 can further comprise conducting test drills with such personnel and/or with the intended passengers (i.e., the authorized beneficiaries of the previously mentioned subscriptions). Such drills can comprise, for examples, drills to practice locating and arriving at the predetermined location 202, assembling at a given rally point, preparing to enter the non-human powered vehicle 203, entering the non-human powered vehicle 203, taking a transport position within the non-human powered vehicle 203, effecting safety provisions within the non-human powered vehicle 203, exiting the non-human powered vehicle 203 (under both emergency and non-emergency conditions), and performing and/or experiencing other circumstances or events of possible relevance or interest. Such drills may also entail, if desired, simulated and/or replicated transport conditions that may pose a particular challenge if encountered during a non-drill transport mission.

These teachings then provide generally for accepting 107 consideration-based private civil security subscriptions 201 from subscribers with respect to providing civilly-catastrophic event-based transport on the non-human powered vehicle 203 away from a location of substantially sudden civil upheaval.

This right of transport can pertain, if desired, to a predetermined timeframe. For example, a given subscription 201 can relate to providing transport as may be required during a given one year period for one or more authorized beneficiaries as are covered by a given subscription. If desired, such a right of transport can be assigned on a seat-by-seat basis. Also if desired, a given subscription can further provide for transportation back to the original location of civic upheaval following substantial quelling of that civil upheaval. This transportation may be by the non-human powered vehicle as was used to originally convey the authorized beneficiaries away from that location or may comprise other more customary civilian-styled transport (presuming, for example, that obstacles and inhibitions with respect to transport are no longer as extreme as when the original transport was provided).

By one approach, these subscriptions may be accepted by, for example, a for-profit business. By another approach a not-for-profit business (such as a membership-based entity) may be the appropriate entity to offer and accept such subscriptions.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of transport (as where a subscription provides transport rights for a specific period of time, such as one year, in exchange for a corresponding series of payments);

event-limited rights of transport (as where a subscription provides transport rights during the life of a given subscriber based upon an up-front payment in full and where those transport rights terminate upon the death of the subscriber or where, for example, a company purchases a subscription for a key employee and those corresponding rights of transport terminate when and if that key employee leaves the employment of that company);

inheritable rights of transport (as may occur when the subscription, by its own terms and conditions, provides a right of transport that extends past the death of a named subscription beneficiary and further allows for testate and/or intestate transfer to an heir);

rights of transport predicated upon a series of periodic payments (as where a subscription provides transport rights during, for example, predetermined periods of time on a periodic basis as where a subscriber offers month-by-month payments to gain corresponding month-by-month transport rights);

rights of transport predicated upon a one-time payment (as may occur when a subscriber makes a single payment to obtain a time-based or event-based duration of transport rights or, if desired, when a single payment serves to acquire a perpetual right of transport that may be retained, transferred, inherited, or the like);

ownership-based rights of transport (as may occur when the subscription provides for ownership rights regarding transport via the non-human powered vehicle);

non-transferable rights of transport (as may occur when the subscription, by its terms and conditions, prohibits transfer of the right of transport from a first named beneficiary to another);

transferable rights of transport (as may occur when the subscription, by its terms and conditions, permits conditional or unconditional transfer of the right of transfer from a first named beneficiary to another);

membership-based rights of transport (as may occur when the subscription, by its terms and conditions, establishes a membership interest with respect to the accorded right of transport such as, for example, a club-based membership);

fractionally-based rights of transport (as may occur when the subscription, by its terms and conditions, establishes a divided or undivided co-ownership interest by and between multiple subscription beneficiaries with respect to a right of transport); and/or

non-ownership-based rights of transport (as may occur when the subscription, by its terms and conditions, establishes the aforementioned right of transport via, for example, a lease, rental, or borrowing construct).

If desired, a plurality of differentiated subscription opportunities can be offered in this regard. This plurality of differentiated subscription opportunities can correspond, for example, to providing access to differing transport modalities, transport accommodations, predetermined locations, and so forth. As but one very simple illustration in this regard, such subscription opportunities can differ from one another at least with respect to cost. This, in turn, provides subscriber choice with respect to selecting a particular subscription that best meets their specific needs and/or budget limitations. For example, one subscription can provide for accessing transport services that are economically selected while another subscription might provide for transport services that are more costly and in turn reflect, for example, a wider variety of choices with respect to transport modality, accommodations, creature comforts, and so forth.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As one option, if desired, this process 100 can further accommodate accepting 108 what amounts to a secondary subscription for secondary transport rights. By this approach, less expensive subscriptions can be provided for transport on a secondary basis of priority. As one example, such a secondary subscription may not assure the authorized beneficiary of a place in the first run of the non-human powered vehicle. If and when the non-human powered vehicle is able to return to the designated location, however, such secondary authorized beneficiaries may then be able to board the vehicle and leave the afflicted area. By one approach, if desired, the primary subscribers could share in the consideration offered by such secondary subscribers.

As noted, these subscriptions relate to providing transport in the event of a civilly-catastrophic event. Such transport may be predicated, if desired, upon a requirement that the civilly-catastrophic event be one that persists in substantial form for more than a predetermined period of time (such as one hour, one day, one week, and so forth) or that causes at least a predetermined amount or degree of civil infrastructure impairment or other measurable impact of choice.

As used herein, “civilly-catastrophic event” will be understood to refer to an event that substantially and materially disrupts a society's local, regional, and/or national infrastructure and ability to provide in ordinary course for the at least one medical service that is the subject of the subscription. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or human-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of human-caused disasters capable of initiating a civilly-catastrophic event include both unintended events as well as acts of war, terrorism, madness or the like. Examples of human-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, and so forth.

For a variety of reasons it may be appropriate to provide a plurality of such predetermined locations 202 in various locations throughout a relatively wide geographic region such as a continent or country. Such a dispersal can aid with reducing the logistic difficulties of transporting authorized beneficiaries during times of need.

These teachings can then of course provide for confirming the occurrence of a triggering civilly-catastrophic event and responsively then permitting subscription-based transport using the aforementioned resources. This may comprise, if desired, use of a mechanism that the authorized beneficiary carries with them to confirm their authorized status in this regard. This mechanism can comprise personal property (such as an identification card) or can comprise, for example, a biometric-based identity authentication process that relies upon fingerprints, retinal patterns, or some other relatively unique aspect of the human body.

It will be appreciated that these teachings provide for a highly flexible yet powerfully effective way by which a modern citizen can greatly improve their likelihood of receiving necessary or helpful transport following a civilly-catastrophic event. These teachings are sufficiently flexible so as to accommodate the needs and desires of a wide-ranging set of potential beneficiaries.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in this regard, this teachings could accommodate the usage of non-powered vehicles as well, such as trailers, gliders, and so forth, lighter-than-air vehicles, and so forth.

We claim:

1. A method comprising:
pre-positioning a non-human-powered vehicle at a predetermined location;
maintaining the non-human-powered vehicle in a substantially constant state of readiness at the predetermined location;
accepting pre-catastrophe consideration-based private civil security subscriptions from subscribers with respect to providing civilly-catastrophic event-based transport on the non-human-powered vehicle away from a location of substantially sudden civil upheaval; such that the non-human-powered vehicle is reserved, maintained, and used substantially solely as a transport response to a civilly-catastrophic event.

2. The method of claim 1 wherein pre-positioning a non-human-powered vehicle at a predetermined location comprises pre-positioning at least one of:
an air-borne vehicle;
a terrestrial vehicle;
a water-borne vehicle;
a hovercraft;
an amphibious vehicle;
a pilotless vehicle;
a remotely piloted vehicle.

3. The method of claim 1 wherein pre-positioning a non-human-powered vehicle at a predetermined location comprises pre-positioning a terrestrial vehicle that is configured and arranged to traverse off-road conditions.

4. The method of claim 1 wherein pre-positioning a non-human-powered vehicle at a predetermined location comprises pre-positioning a terrestrial vehicle that is configured and arranged to travel compatibly on both paved surfaces and railroad tracks.

5. The method of claim 1 wherein pre-positioning a non-human-powered vehicle at a predetermined location comprises pre-positioning a terrestrial vehicle that is configured and arranged to transport human passengers comprising authorized beneficiaries of the subscriptions.

6. The method of claim 5 wherein pre-positioning a non-human-powered vehicle at a predetermined location comprises pre-positioning a terrestrial vehicle that is further configured and arranged to additionally transport non-human cargo.

7. The method of claim 1 wherein maintaining the non-human-powered vehicle comprises maintaining the non-human-powered vehicle in a covered shelter for at least a substantial period of time pending a civilly-catastrophic event.

8. The method of claim 1 wherein maintaining the non-human-powered vehicle comprises at least one of:
conducting vehicle maintenance;
providing a supplemental supply of fuel in relatively close proximity to the non-human powered vehicle, which supplemental supply of fuel is dedicated to use with the non-human powered vehicle;
providing a store of spare parts for the non-human-powered vehicle at the predetermined location;
test-driving the non-human-powered vehicle from time to time;
test-operating the non-human-powered vehicle from time to time.

9. The method of claim 1 wherein pre-positioning a non-human-powered vehicle comprises pre-positioning a non-human-powered vehicle having a passenger cabin that is substantially airtight.

10. The method of claim 9 wherein pre-positioning a non-human-powered vehicle further comprises pre-positioning a non-human-powered vehicle that is configured and arranged to at least selectively have positive air pressure within a passenger cabin thereof.

11. The method of claim 1 wherein pre-positioning a non-human-powered vehicle at a predetermined location comprises pre-positioning at least two non-human-powered vehicles at the predetermined location such that the pre-positioned non-human-powered vehicles at the predetermined location comprise passenger transport capacity that is at least twice a passenger capacity as is represented by the subscriptions.

12. The method of claim 1 wherein pre-positioning a non-human-powered vehicle at a predetermined location comprises pre-positioning a plurality of non-human-powered vehicles at the predetermined location, wherein at least two of the plurality of non-human-powered vehicles have differing transport modalities.

13. The method of claim 1 further comprising:
providing an airstrip at the predetermined location;
reserving ordinary use of the airstrip for use by the non-human-powered vehicle.

14. The method of claim 1 further comprising:
providing at least one full-time crew member for the non-human-powered vehicle.

15. The method of claim 14 wherein providing at least one full-time crew member for the non-human-powered vehicle further comprises pre-positioning the at least one full-time crew member at the predetermined location such that the at least one full-time crew member is available to facilitate substantially immediate operation of the non-human-powered vehicle in response to a civilly-catastrophic event.

16. The method of claim 1 wherein pre-positioning a non-human-powered vehicle at a predetermined location comprises pre-positioning:
a first non-human-powered vehicle comprising a passenger vehicle to transport authorized beneficiaries of the subscriptions; and
a second non-human-powered vehicle comprising a security vehicle to accompany the first non-human-powered vehicle when the first non-human-powered vehicle is transporting the authorized beneficiaries away from the location of substantially sudden civil upheaval.

17. The method of claim 1 wherein maintaining the non-human-powered vehicle in a substantially constant state of readiness at the predetermined location comprises conducting test drills with the non-human-powered vehicle.

18. The method of claim 17 wherein conducting test drills with the non-human-powered vehicle further comprises conducting test drills with authorized beneficiaries of the subscriptions.

19. The method of claim 1 wherein the subscriptions comprise at least one of:
time-limited rights of transport;
event-limited rights of transport;
inheritable rights of transport;
rights of transport predicated upon a series of periodic payments;
rights of transport predicated upon a one-time payment;
ownership-based rights of transport;
non-transferable rights of transport;
transferable rights of transport;
membership-based rights of transport;
fractionally-based rights of transport;
non-ownership-based rights of transport.

20. The method of claim 1 wherein the subscriptions are provided on a seat-by-seat basis.

21. The method of claim 1 wherein a given one of the subscriptions provides for compensation being provided to a subscriber of that given subscription when the non-human-powered vehicle has completed the transport of passengers as per that given subscription and is then used subsequently to transport additional passengers away from the location of substantially sudden civil upheaval.

22. The method of claim 1 further comprising:
accepting pre-catastrophe consideration-based private civil security secondary subscriptions from subscribers with respect to providing civilly-catastrophic event-based secondary transport on the non-human-powered vehicle away from a location of substantially sudden civil upheaval, which secondary transport is provided following completion of transporting a primary class of authorized beneficiaries away from the location of substantially sudden civil upheaval.

23. The method of claim 1 wherein the subscriptions further provide for returning non-powered-vehicle passengers back to the location of substantially sudden civil upheaval following substantially quelling of that civil upheaval.

24. The method of claim 1 further comprising:
acquiring an exclusive right to operate the non-human-powered vehicle.

25. The method of claim 24 wherein acquiring an exclusive right to operate the non-human-powered vehicle comprises acquiring the exclusive right via:
ownership;
leasing;
rental;
barter.

26. The method of claim 1 wherein pre-positioning a non-human-powered vehicle comprises pre-positioning a non-human-powered vehicle that is pre-supplied with at least one of:
body armor;
radiation shielding;
biological/chemical agent protection;
medical supplies;
spare vehicle parts;
self-rescue gear;
vehicular maintenance tools;
non-lethal weapons and ammunition;
supplemental vehicular fuel supplies.

27. The method of claim 1 wherein pre-positioning a non-human-powered vehicle comprises pre-positioning a non-human-powered vehicle that has at least its critical vulnerable systems substantially protected against an electromagnetic pulse.

28. An apparatus comprising:
a predetermined location;
at least one non-human-powered vehicle disposed at the predetermined location, wherein the non-human-powered vehicle is maintained in a substantially constant state of readiness;
a plurality of pre-catastrophe consideration-based private civil security subscriptions from subscribers with respect to providing civilly-catastrophic event-based transport on the non-human-powered vehicle away from a location of substantially sudden civil upheaval; such that the non-human-powered vehicle is reserved, maintained, and used substantially solely as a transport response to a civilly-catastrophic event.

29. The apparatus of claim 28 wherein the non-human-powered vehicle comprises at least one of:
an air-borne vehicle;
a terrestrial vehicle;
a water-borne vehicle;
a hovercraft;
an amphibious vehicle;
a pilotless vehicle;
a remotely piloted vehicle.

30. The apparatus of claim 28 wherein the non-human-powered vehicle comprises a terrestrial vehicle that is configured and arranged to traverse off-road conditions.

31. The apparatus of claim 28 wherein the non-human-powered vehicle is configured and arranged to travel compatibly on both paved surfaces and railroad tracks.

32. The apparatus of claim 28 wherein the non-human-powered vehicle is configured and arranged to transport human passengers comprising authorized beneficiaries of the subscriptions.

33. The apparatus of claim 32 wherein the non-human-powered vehicle is further configured and arranged to additionally transport non-human cargo.

34. The apparatus of claim 28 wherein the predetermined location comprises, at least in part, a covered shelter for the non-human-powered vehicle.

35. The apparatus of claim 28 wherein the non-human-powered vehicle comprises a passenger cabin that is substantially airtight.

36. The apparatus of claim 35 wherein the non-human-powered vehicle is configured and arranged to at least selectively have positive air pressure within a passenger cabin thereof.

37. The apparatus of claim 28 comprising at least two non-human-powered vehicles disposed at the predetermined location such that the pre-positioned non-human-powered vehicles at the predetermined location comprise passenger transport capacity that is at least twice a passenger capacity as is represented by the subscriptions.

38. The apparatus of claim 28 wherein the predetermined location comprises an airstrip that is ordinarily reserved for use by the non-human-powered vehicle.

39. The apparatus of claim 28 wherein the predetermined location further comprises living quarters for at least one full-time crew member for the non-human-powered vehicle.

40. The apparatus of claim 28 wherein the non-human-powered vehicle comprises a passenger vehicle to transport authorized beneficiaries of the subscriptions, and wherein the apparatus further comprises:
a second non-human-powered vehicle comprising a security vehicle to accompany the non-human-powered vehicle when the non-human-powered vehicle is transporting the authorized beneficiaries away from the location of substantially sudden civil upheaval.
